(19) United States
(12) Patent Application Publication
(10) Pub. No.: US 2024/0154756 A1
(43) Pub. Date: May 9, 2024

(54) OVER THE AIR FREQUENCY DEPENDENT RESIDUAL SIDE BAND ESTIMATION

(71) Applicant: QUALCOMM Incorporated, San Diego, CA (US)

(72) Inventors: Gideon Shlomo Kutz, Ramat Hasharon (IL); Ronen Shaked, Kfar Saba (IL); Aviv Regev, Tel Aviv (IL)

(21) Appl. No.: 18/052,858

(22) Filed: Nov. 4, 2022

(51) Int. Cl. H04L 5/00; H04L 25/02; H04W 24/10

(52) U.S. Cl. CPC H04L 5/0051; H04L 25/0256; H04W 24/10

(57) ABSTRACT

Aspects of the present disclosure also allow for a more efficient way to correct or compensate for IQ mismatch in an environment with multiple TX antennas and multiple IQ modulators. In these environments, a received signal is a beamformed signal which is a combination of all TX antennas passing through different channels and may be received in a single RX antenna. Specifically, the RX side may estimate the composite FDRSB for the TXs and signal back a composite FDRSB to allow the TX to use a single filter to compensate for the composite FDRSB. The composite FDRSB may correspond to the equivalent FDRSB received as a sum of the individual FDRSBS of each of the IQ modulators and IQ antennas at a base station.

### TECHNICAL FIELD

The present disclosure generally relates to communication systems, and more particularly, to systems and methods for estimating over-the-air frequency dependent in-phase (I) and quadrature (Q) mismatch.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the subject matter described in this disclosure can be implemented in an apparatus for wireless communication. The apparatus includes a memory and at least one processor coupled to the memory. The processor is configured to receive a dedicated pilot signal for frequency dependent residual side band (FDRSB) measurement associated with a plurality of antennas of a base station (BS). The processor is also configured to transmit a report including a reported value associated to a composite FDRSB value at the apparatus.

In another aspect, the subject matter described in this disclosure can be implemented in an apparatus for wireless communication. The apparatus includes a memory and at least one processor coupled to the memory. The processor is configured to transmit a dedicated pilot signal for FDRSB measurement associated with a plurality of antennas of the apparatus. The processor is also configured to receive a report including a reported value associated to a composite FDRSB value at the apparatus

In another aspect, the subject matter described in this disclosure can be implemented in a method of wireless communication at a UE. The method includes receiving a dedicated pilot signal for FDRSB measurement associated with a plurality of antennas of a BS. The method also includes transmitting a report including a reported value associated to a composite FDRSB value at the UE.

In another aspect, the subject matter described in this disclosure can be implemented in a method of wireless communication at a base station. The method includes transmitting a dedicated pilot signal for FDRSB measurement associated with a plurality of antennas of the BS. The method also includes receiving a report including a reported value associated to a composite FDRSB value at a UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating an example disaggregated base station architecture.

FIG. 3A is a diagram illustrating an example of a first frame, in accordance with various aspects of the present disclosure.

FIG. 3B is a diagram illustrating an example of downlink channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink channels within a subframe, in accordance with various aspects of the present disclosure.

FIG. 4 is a diagram illustrating an example of a base station and user equipment (UE) in an access network.

FIG. 5 illustrates an example of an over-the-air (OTA) estimation of frequency dependent residual side band (FDRSB) between a beamforming transmitter and a receiver.

FIGS. 6A-6D illustrates an example signaling procedure for frequency dependent residual side band (FDRSB) between a base station (BS) and multiple user equipment (UEs).

FIG. 7 illustrates a call flow diagram between a base station and a wireless device.

FIGS. 8 through 9 illustrate example flowcharts illustrating methods of wireless communication at a UE.

FIGS. 10 through 12 illustrate example flowcharts illustrating a method of wireless communication at a BS.

FIG. 13 is a diagram illustrating an example of a hardware implementation for an example apparatus.

FIG. 14 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Some wireless communication systems, such as 4G and 5G systems, may experience an inphase and quadrature-phase (IQ) mismatch (also referred to as an IQ imbalance), which may impact wireless communications between communication devices. An I/Q mismatch includes a mismatch of a gain or a phase between an inphase and quadrature-phase of a signal (e.g., an uplink signal, a downlink signal). In addition, an IQ mismatch may pose a challenge on performance of the wireless communications systems by decreasing reliability and increasing latency for wireless communications between communication devices.

Frequency dependent inphase (I) and quadrature (Q) mismatch is a major impairment that may limit the achievable rate in a wideband communication system if not estimated and compensated for. A specific impairment may be a frequency dependent residual side band (FDRSB) that relates to a mismatch between IQ components. FDRSB is an impairment due to the nature of analog circuits in any communication chips, but currently has not been an issue in 5G or previous generations of communications. However, the trend for future communications is trending towards using larger bandwidths and the impairment has been made more severe due to the use of larger bandwidths.

In modern base stations, multiple antennas are used such that the antennas utilize multiple IQ modulators and the span different panels and remote radio head (RRH) units. In addition, beamforming is used so that the receiver may receive a composite FDRSB from all of the different IQ modulators. The transmitter cannot estimate the composite FDRSB on the transmitting (TX) side without knowledge of the channel coefficients and without creating the receiving (RX) beam as seen on the user equipment (UE) side. This limits the accuracy of the FDRSB cancellation. As such, in the current solution, the base station has to compensate each IQ modulator separately, which requires additional HW and power consumption.

As 5G New Radio (NR) trends towards the usage of more bandwidth and more RX antennas receiving beamformed signals, these trends give rise to the problem of FDRSB. Aspects of the present disclosure disclose a receiver transmitting an estimated composite FDRSB for a transmitter to use to compensate the FDRSBs of its IQ modulators. This allows multiple FDRSB measurements to be represented and estimated by a single composite FDRSB which saves resources for estimation and signaling when the estimation can be performed on the RX side. As will be explained below, enabling a single filter compensation for FDRSB by estimating the composite FDRSB over the air may require shorter training time, lower cost, and better estimation and cancellation accuracy.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

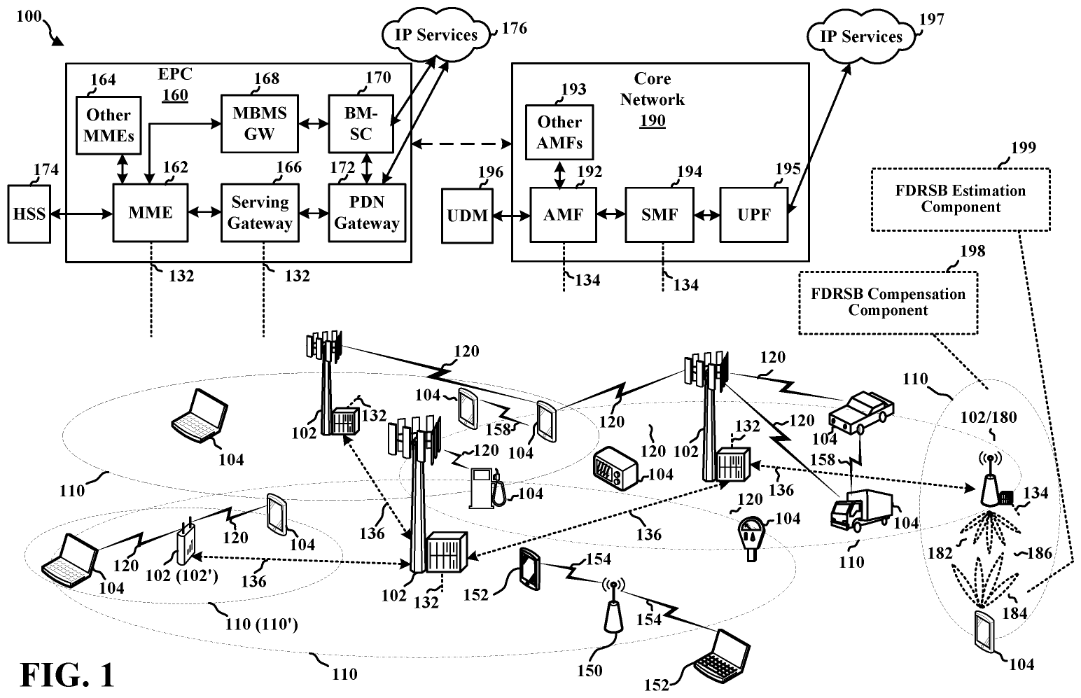

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells, such as high power cellular base stations, and/or small cells, such as low power cellular base stations (including femtocells, picocells, and microcells).

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR), which may be collectively referred to as the Next Generation Radio Access Network (RAN) (NG-RAN), may interface with a core network 190 through second backhaul links 134. In addition to other functions, the base stations 102 may perform one or more of: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 200 may be configured to utilize a protocol stack that is physically or logically distributed among two or more units (such as one or more central units (CU), one or more distributed units (DUs), or one or more radio units (RUs)). In some aspects, a CU 210 may be implemented within a RAN node, and one or more DUs 230 may be co-located with the CU 210, or alternatively, may be geographically or virtually distributed throughout one or multiple other RAN nodes. The DUs 230 may be implemented to communicate with one or more RUs 240. Each of the CU 210, DU 230 and RU 240 also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1, in certain aspects, the UE 104 may include an FDRSB estimation component 199 that is configured to: receive a dedicated pilot signal for FDRSB measurement associated with a plurality of antennas of a BS and transmit a report including a reported value associated to a composite FDRSB value at the apparatus.

In certain aspects, the base station 102/180 may include a FDRSB compensation component 198 that is configured to: transmit a dedicated pilot signal for FDRSB measurement associated with a plurality of antennas of the apparatus, and receive a report including a reported value associated to a composite FDRSB value at the apparatus.

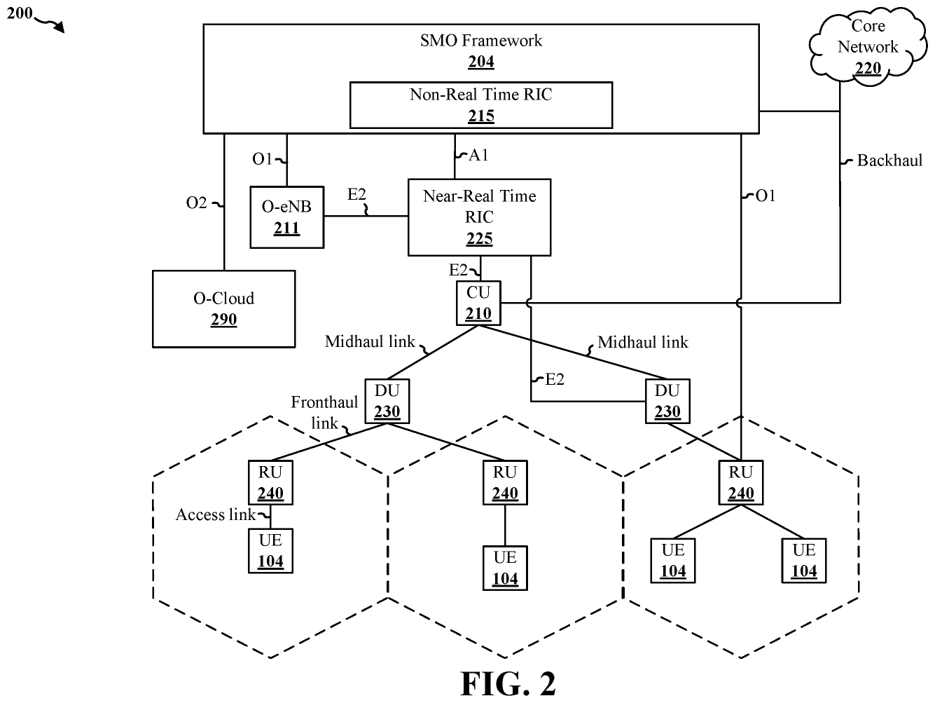

FIG. 2 shows a diagram illustrating an example disaggregated base station 200 architecture. The disaggregated base station 200 architecture may include one or more CUs 210 that can communicate directly with core network 220 via a backhaul link, or indirectly with the core network 220 through one or more disaggregated base station units (such as a Near-Real Time RIC 225 via an E2 link, or a Non-Real Time RIC 215 associated with a Service Management and Orchestration (SMO) Framework 204, or both). A CU 210 may communicate with one or more DUs 230 via respective midhaul links, such as an F1 interface. The DUs 230 may communicate with one or more RUs 187 via respective fronthaul links. The RUs 240 may communicate respectively with UEs 104 via one or more radio frequency (RF) access links. In some implementations, the UE 104 may be simultaneously served by multiple RUs 240.

Each of the units, i.e., the CUs 210, the DUs 230, the RUs 240, as well as the Near-RT RICs 225, the Non-RT RICs 215 and the SMO Framework 204, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 204 may be configured to support RAN deployment and provisioning of non-virtualized and virtualized network elements. For non-virtualized network elements, the SMO Framework 204 may be configured to support the deployment of dedicated physical resources for RAN coverage requirements, which may be managed via an operations and maintenance interface (such as an O1 interface). For virtualized network elements, the SMO Framework 204 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 204 can communicate with a hardware aspect of a 4G RAN, such as an open eNB (O-eNB) 211, via an O1 interface. Additionally, in some implementations, the SMO Framework 204 can communicate directly with one or more RUs 240 via an O1 interface. The SMO Framework 204 also may include the Non-RT RIC 215 configured to support functionality of the SMO Framework 204.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 204 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 204 (such as reconfiguration via 01) or via creation of RAN management policies (such as A1 policies).

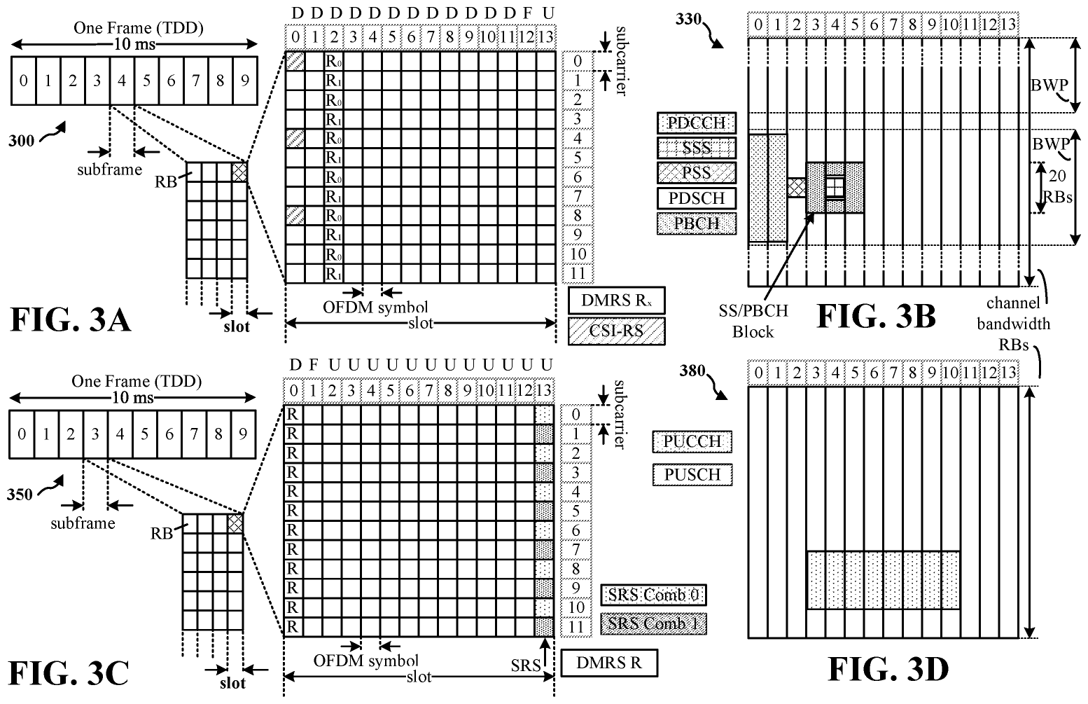

FIG. 3A is a diagram 300 illustrating an example of a first subframe within a 5G NR frame structure. FIG. 3B is a diagram 330 illustrating an example of downlink channels within a 5G NR subframe. FIG. 3C is a diagram 350 illustrating an example of a second subframe within a 5G NR frame structure. FIG. 3D is a diagram 380 illustrating an example of uplink channels within a 5G NR subframe. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 3A and 3C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix CP-OFDM symbols. The symbols on uplink may be CP-OFDM symbols (for high throughput scenarios) or DFT-s-OFDM symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ*15} kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (s). Within a set of frames, there may be one or more different bandwidth parts (BWPs) (see FIG. 3B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rx for one particular configuration, where 100× is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 3B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. A UE (such as a UE 104 of FIG. 1) may use the PSS to determine subframe/symbol timing and a physical layer identity. A secondary synchronization signal (SSS) may be within symbol 4 of particular subframes of a frame. A UE (such as a UE 104 of FIG. 1) may use the SSS to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 3D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

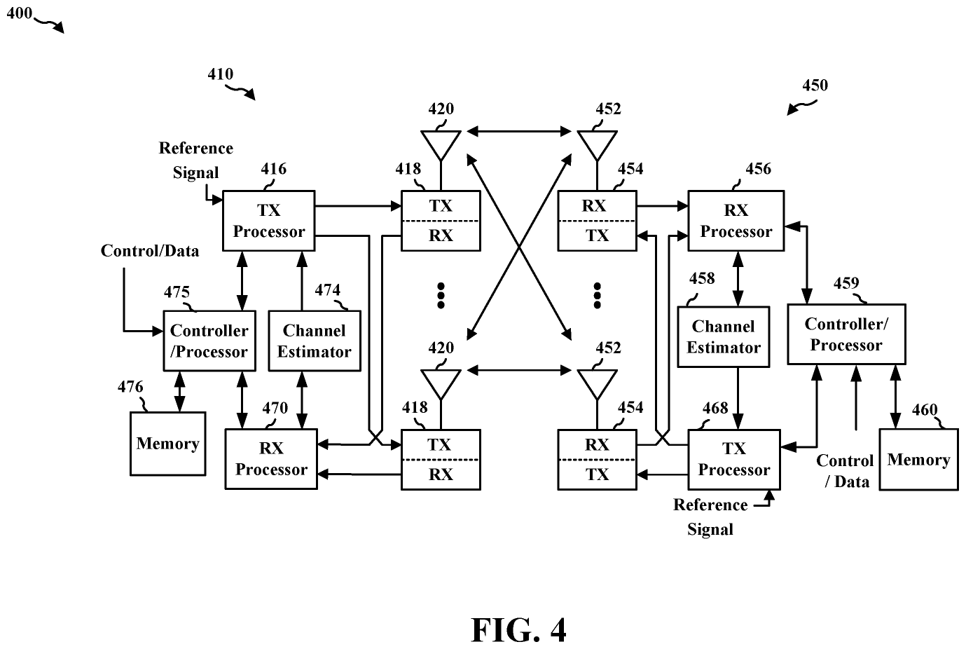

FIG. 4 is a block diagram of a base station 410 in communication with a UE 450 in an access network 400. In the downlink, IP packets from the EPC 160 may be provided to a controller/processor 475. The controller/processor 475 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418TX. Each transmitter 418TX may modulate a radio frequency (RF) carrier with a respective spatial stream for transmission.

At the UE 450, each receiver 454RX receives a signal through at least one respective antenna 452. Each receiver 454RX recovers information modulated onto an RF carrier and provides the information to the receive (RX) processor 456. The TX processor 468 and the RX processor 456 implement L1 functionality associated with various signal processing functions. The RX processor 456 may perform spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements L3 and L2 functionality.

The controller/processor 459 can be associated with a memory 460 that stores program codes and data. The memory 460 may be referred to as a computer-readable medium. In the uplink, the controller/processor 459 provides demultiplexing between transport and logical channels, packet reassembly, deciphering, header decompression, and control signal processing to recover IP packets from the EPC 160. The controller/processor 459 is also responsible for error detection using an ACK and/or NACK protocol to support HARQ operations.

Similar to the functionality described in connection with the downlink transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The uplink transmission is processed at the base station 410 in a manner similar to that described in connection with the receiver function at the UE 450. Each receiver 418RX receives a signal through at least one respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. In the uplink, the controller/processor 475 provides demultiplexing between transport and logical channels, packet reassembly, deciphering, header decompression, control signal processing to recover IP packets from the UE 450. IP packets from the controller/processor 475 may be provided to the EPC 160. The controller/processor 475 is also responsible for error detection using an ACK and/or NACK protocol to support HARQ operations.

At least one of the TX processor 468, the RX processor 456, and the controller/processor 459 may be configured to perform aspects in connection with the FDRSB estimation component 199 of FIG. 1.

At least one of the TX processor 416, the RX processor 470, and the controller/processor 475 may be configured to perform aspects in connection with the FDRSB compensation component 198 of FIG. 1.

As 5G NR is moving toward the usage of more bandwidth and RX antennas, these trends give rise to the problem of FDRSB. In the 5G NR environments, the transmitter is unable to estimate a composite FDRSB due to channel coefficients and channel response not being known at the TX. Therefore, the TX cannot estimate the composite FDRSB as in the previous solution and, instead, must compensate for each of the I/Q mismatches separately. In addition, the FDRSB may change as a function of temperature. Therefore, online FDRSB calibration is needed.

FDRSB is a frequency dependent IQ mismatch. Specifically, RSB is a combination of amplitude and phase imbalance between the inphase (I) signal and the quadrature (Q) signal in IQ circuitry. Generally, an electronic device may include separate branches for the I and Q signals. Ideally, the I and Q branch have equal gain with a 90 degree phase difference from each other. However, imbalances may exist between the I branch and the Q branch. These imbalances may degrade the performance of the electronic device. To correct these imbalances, a correction may be performed.

In addition, IQ mismatch is created at an IQ modulator. The current solution involves creating a loopback in the immediate frequency (IF) domain. By looping back an output of the IQ modulator, a transmitter can estimate the IQ mismatch that occurred on the TX side and compensate for this IQ mismatch. However, this estimation and compensation is to be performed per each IQ modulator. Accordingly, if there are multiple IQ modulators (e.g., such as in 5G NR systems), then there will also be multiple IQ modulators that each need to be compensated for with the TX loopback. This means that each of the FDRSB created by each of the IQ modulators will need to be compensated separately, which is costly due to the large number of loop back processes. Furthermore, this process may be less appropriate for highly beamformed environments since the highly beamformed environments will involve multiple antennas, different panels of antennas, and different remote radio head (RRH) units.

Aspects of the present disclosure discuss how to correct or compensate for IQ mismatch in environments containing multiple TX antennas and multiple IQ modulators. In these environments, the received signal is beamformed as a combination of all TX antennas passing through different channels and may be received by a single RX antenna. A beamformed signal may generally refer to a signal that is transmitted from a device having multiple antennas, and the beamformed signal may be steered in a particular direction (e.g., towards an intended receiver) by controlling signals transmitted from multiple antennas.

Aspects of the present disclosure also allow for a more efficient way to correct or compensate for IQ mismatch in an environment with multiple TX antennas and multiple IQ modulators. In these environments, a received signal is a beamformed signal which is a combination of all TX antennas passing through different channels and may be received in a single RX antenna. Specifically, the RX side may estimate the composite FDRSB for the TXs and signal back a composite FDRSB to allow the TX to use a single filter to compensate for the composite FDRSB. The composite FDRSB may correspond to the equivalent FDRSB received as a sum of the individual FDRSBS of each of the IQ modulators and IQ antennas at a base station.

Aspects of the present disclosure estimate the FDRSB composite on-line by over-the-air (OTA) computation and having the UEs assist a base station in estimating the composite FDRSB. This allows multiple FDRSB measurements to be represented and estimated by a single FDRSB which saves resources for estimation and signaling when the estimation is performed on the RX side.

As demand for wireless communication efficiency increases, various aspects of the present disclosure may provide improvements to IQ mismatch estimation to support higher reliability and lower latency wireless communication. The techniques described below allow a shorter training because there is no need to send a training signal to every IQ modulator separately and instead training is performed on the composite signal. In addition, there is a lower cost of hardware because there is no longer a need to have a feedback pass per each IQ modulator. Furthermore, better estimation and cancellation accuracy is possible because the base station may utilize multiple UEs for estimating the composite FDRSB via federated learning. The base station may request many way to estimate the composite FDRSB and average the feedback. Thus, the quality and accuracy of the estimation is improved.

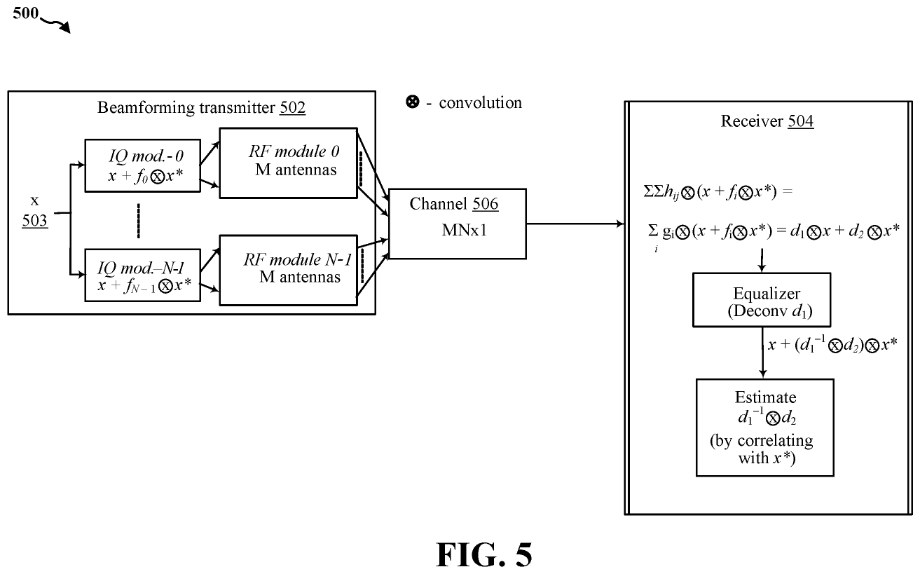

FIG. 5 illustrates an example 500 of an OTA estimation of FDRSB between a beamforming transmitter 502 and a receiver 504. Specifically, example 500 depicts an example showing mathematical representations of estimating a single composite response by the receiver 504.

As shown in example 500, the beamforming transmitter 502 may have N number of IQ modulators that are each connected to M number of antennas. In addition, each of the IQ modulators is characterized by a different IQ mismatch, which is modeled with N filters (f₀, . . . f_{N-1}) operating on the complex conjugate of the input signal (possibly representing different modules, RRHs, etc.).

On the RX side, a signal x 503 passes through different IQ modulators such that each IQ modulator outputs the signal x 503 plus a corresponding filter (e.g., f₀, . . . f_{N-1}) for the IQ modulator. In the IQ modulators, f is indexed from 0 to N−1 and represent different filter such that the filter f will operate on the conjugate of the signal x 503. As such, each IQ modulator show signal x 503 itself and a filter f operating on its conjugate. Here, there are N such outputs and each of these outputs goes into an M antenna for the RF modules. Similar to the IQ modulators, the RF modules are also accordingly indexed from 0 to N−1. The outputs of the RF modules will be input into a channel with dimensions M x N TX antennas and then transmitted into a single RX antenna on the receiver 504. If there is more than one Rx antennas, then this process will be repeated for each RX antenna.

On the RX side, the signals from the TX side are summed and a FDRSB estimation is determined which is then translated to a single composite FDRSB. Described herein * refers to a convolution function. Specifically, the output of the channel 506 is a composite response d₁ convolved with x plus d₂* with x conjugate. Accordingly, at the RX side, even though there are N different IQ modulators (each contributing a different IQ mismatch), this can be translated into a composite FDRSB. The receiver 504 also has two filters d₁ and d₂. d₁ is associated with the conventional composite channel as a result of aggregating all the TX antennas and may be handled conventionally by performing an equalization (deconvolution of d₁) to obtain an output of x (which is also the signal to be extracted) plus a term representing the FDRSB distortion that was created. Next, the equivalent filter (e.g., d₁⁻¹*d₂) is convolved with x conjugate (x*). In other words, (d₁⁻¹*d₂) represents the FDRSB distortion that has happened. Subsequently, if x conjugate (x*) is treated as a pilot signal (e.g., assumed to be a known signal), then correlation with the pilot signal may occur and the FDRSB can be estimated. Finally, the output of the receiver 504 is a term which represents the composite FDRSB (or the composite IQ mismatch) and the term is sent back to the beamforming transmitter 502 so that the beamforming transmitter 502 may now compensate for the FDRSB based on a single composite FDRSB estimate.

FIG. 5 also shows that estimation of the composite response by the beamforming transmitter 502 is not possible without complete knowledge of the channel on the TX side. Thus, estimation per IQ modulator will require N separate training sessions and N correction filters. In contrast, example 500 describes a technique that allows the system to train on the composite signal rather than to train every IQ modulator separately.

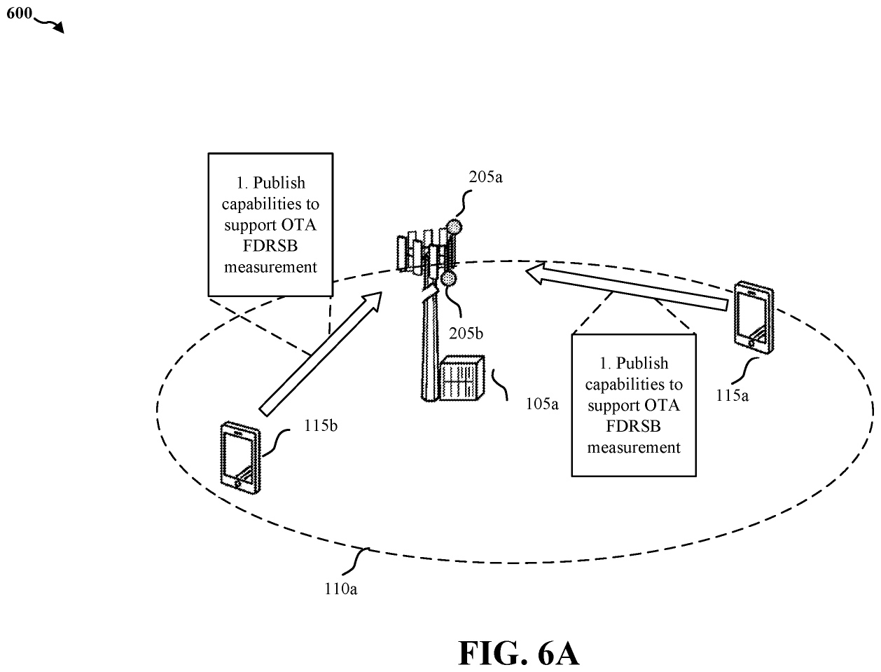

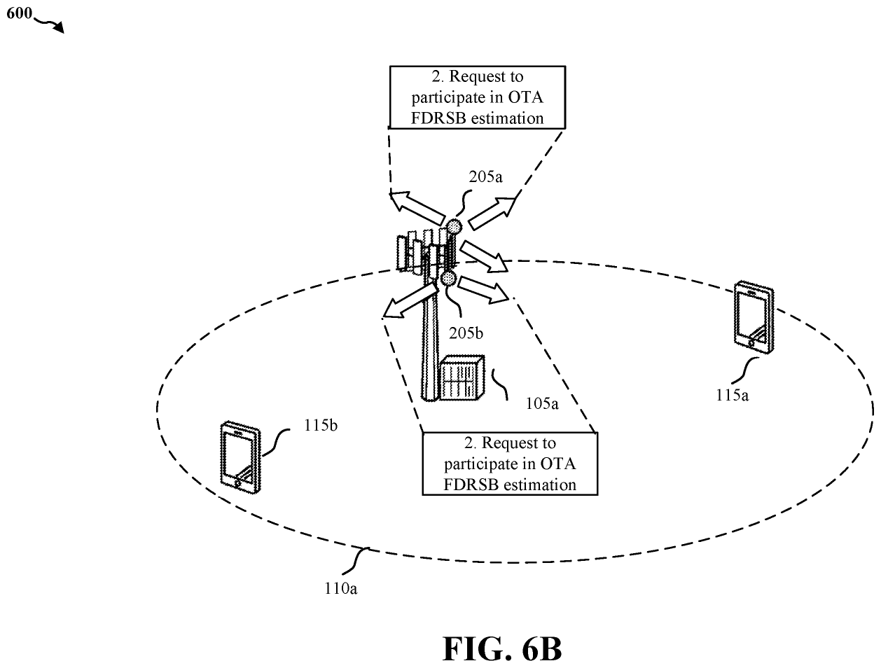

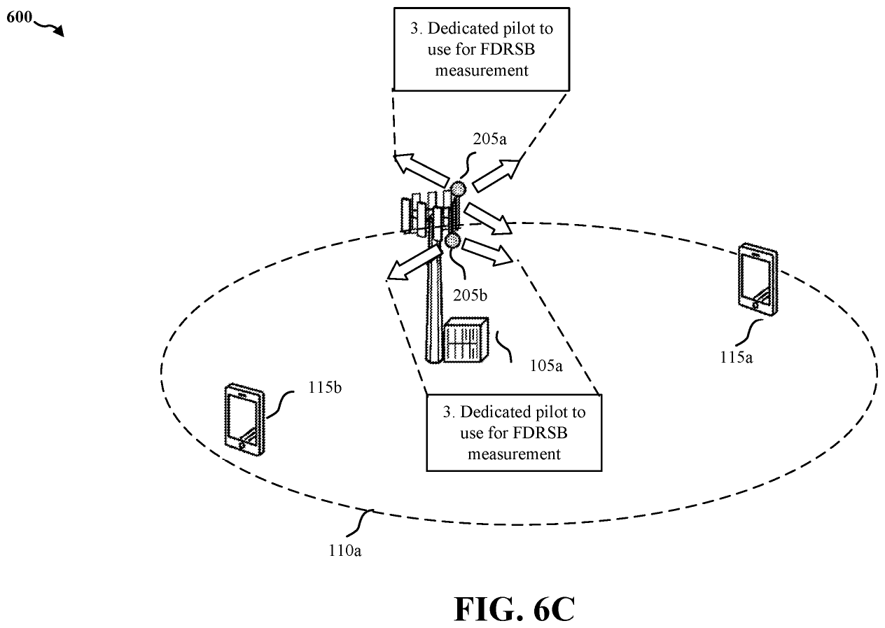

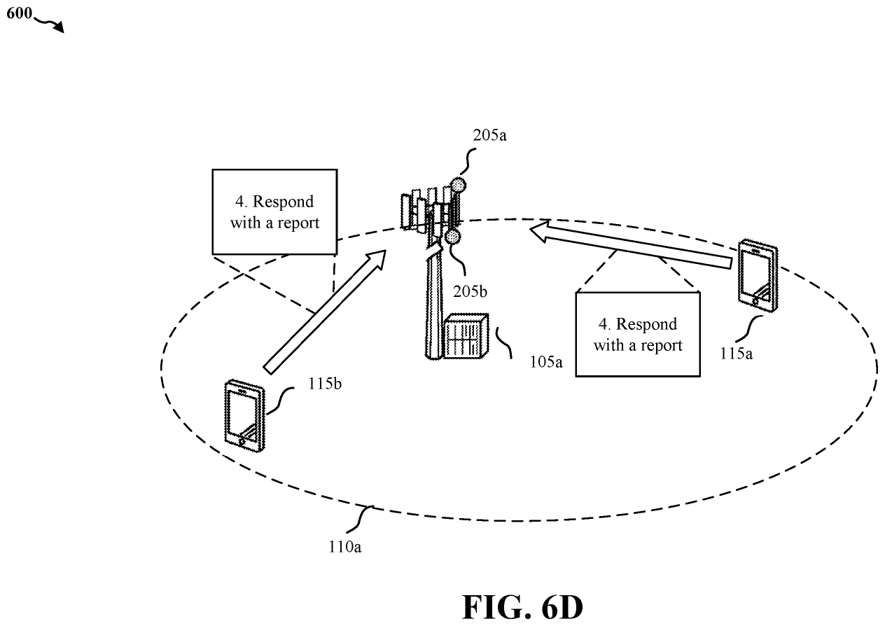

FIG. 6A-6D illustrates an example of a wireless communications system 600 that supports signaling procedure for FDRSB between a BS and multiple UEs. In some examples, the wireless communications system 600 may include a base station 105a and UEs 115a and 115b, which may be examples of a base station 102/180 and UEs 104 as described with reference to FIG. 1. For example, the wireless communications systems 600 may include a base station 105a and UES 115a and 115b as described with reference to FIG. 1. The base station 105a may serve geographic coverage area 110a. The base station 105a may include a number of antennas 205a and 205b (e.g., transmit antennas, receive antennas, or any combination thereof) for transmitting signals to the UEs 115 (e.g., on a downlink channel). Each antenna 205a or 205b may correspond to a physical antenna, a logical antenna port, an antenna array, a component of an antenna array, or some combination thereof. In some cases, transmissions from the antenna 205a and 206b may experience IQ mismatch (e.g., based on the receiver chains at the UEs 115 and the inphase signal path, the quadrature signal path, or both for the transmissions). Such an IQ mismatch at the base station antennas 205 may set a noise floor for the receiving UEs 115, reducing the reliability of successful reception for specific messages, such as messages corresponding to relatively high modulation and coding scheme (MCS) values, messages corresponding to multiple streams using MIMO, or other similar messages. To correct for the IQ mismatch, the wireless communications system 600 may support IQ mismatch estimation for the base station antennas 205 at the UEs 115.

In other systems, the base station 105a may perform IQ mismatch estimation. For the base station 105a to support IQ mismatch estimation, the base station 105a may implement a number of hardware components, software components, or a combination thereof per antenna (e.g., per transmit antenna). Such a base station configuration may result in increased processing complexity and overhead at the base station 105a in order to support local feedback and estimation of IQ mismatch for each antenna at the base station 105a.

In contrast, as described herein, the wireless communications system 600 may support a signaling procedure for performing IQ mismatch estimation and reporting by one or more UEs 115. For improved estimation, the base station 105a may average FDRSB measurements from multiple UEs 115a and 115b if the UEs are served by a same TX beam.

As shown in FIG. 6A, the UEs 115a and 115b might publish capabilities to support OTA FDRSB measurement. As shown in FIG. 6B, the base station 105a may send a request for a group of UEs 115a and 115b to participate in OTA FDRSB estimation. As shown in FIG. 6C, the base station 105b will send a dedicated pilot for the UEs 115a and 115b to use for FDRSB measurement. The dedicated pilot may also be referred to as a dedicated reference signal (DRS), a UE-specific reference signal (UE-RS), etc. The cell may transmit the dedicated pilot on some of the downlink resources used for data transmission and may process (e.g., precode) the dedicated pilot in similar manner as for the data transmission. The dedicated pilot would then observe the same overall channel as the data transmission. The recipient UE may obtain a channel estimate for the cell based on the dedicated pilot, without having to know the processing (e.g., precoding and power scaling) performed by the cell for the dedicated pilot and the data transmission. As shown in FIG. 6D, the UEs 115a and 115b will respond a report including a value associated to a equivalent (or composite) FDRSB value at the apparatus. As shown above, the UE does not estimate anything per antenna since it cannot separate to per antenna FDRSB and is also not needed. In some implementations, the report will include a x*^{H}(yₙ−x) correlation measurement, which is also a reported value associated to an equivalent (or composite) FDRSB at the UE. Here, since yₙ=x+c⊗x*+wₙ represents the signal model at the n-th UE, each UE may send x*^{H}(yₙ−x), which is a short vector of correlation results with a length that is the expected number of taps in c, where c is a column vector of the filter taps to be estimated.

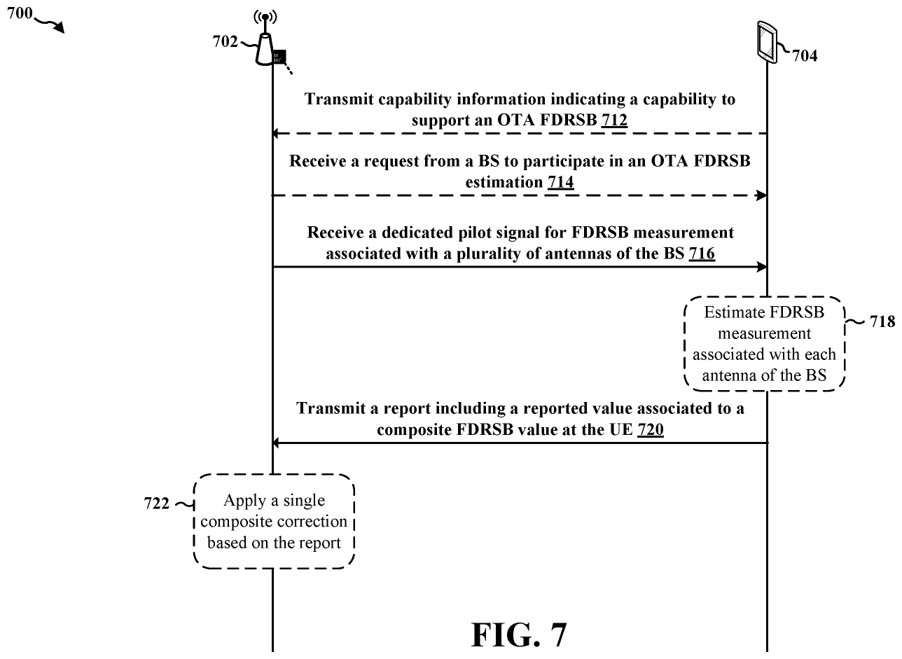

FIG. 7 is diagram illustrating a call flow between a BS 702 and a UE 704. A process flow 700 illustrates an exemplary sequence of operations performed between the BS 702 and UE 704 to support OTA FDRSB estimation at the UE. For example, process flow 700 depicts operations for estimating a composite FDRSB over the air by having the UE 704 assist the BS 702. It is understood that one or more of the operations described in process flow 700 may be performed earlier or later in the process, omitted, replaced, supplemented, or combined with another operation. Also, additional operations described herein that are not included in process flow 700 may be included in process flow 700.

Initially, in an aspect, the UE 704 transmits a capability information indicating a capability to support an OTA FDRSB 712. For example, referring back to FIG. 6A, the UEs 115a and 115b publish capabilities to support OTA FDRSB measurement.

In an aspect, in response to transmitting the capability information, the UE 704 receives a request from the BS 702 to participate in an OTA FDRSB estimation 714. For example, referring back to FIG. 6B, the BS 702 transmits a request to participate in OTA FDRSB estimation to the UEs 115a and 115b.

The UE 704 receives a dedicated pilot signal for FDRSB measurement associated with a plurality of antennas of the BS 716. For example, referring back to FIG. 6C, the BS 702 transmit a dedicated pilot to use for FDRSB measurement.

In an aspect, the UE 704 estimates FDRSB measurement associated with each antenna of the BS. For example, referring back to FIG. 5, the receiver 504 may estimate d₁⁻¹*d₂ by correlating with x conjugate.

Next, the UE 704 transmits a report including a reported value associated to a composite FDRSB value at the UE 720.

In an aspect, the BS 702 applies a single composite correction based on the report 722.

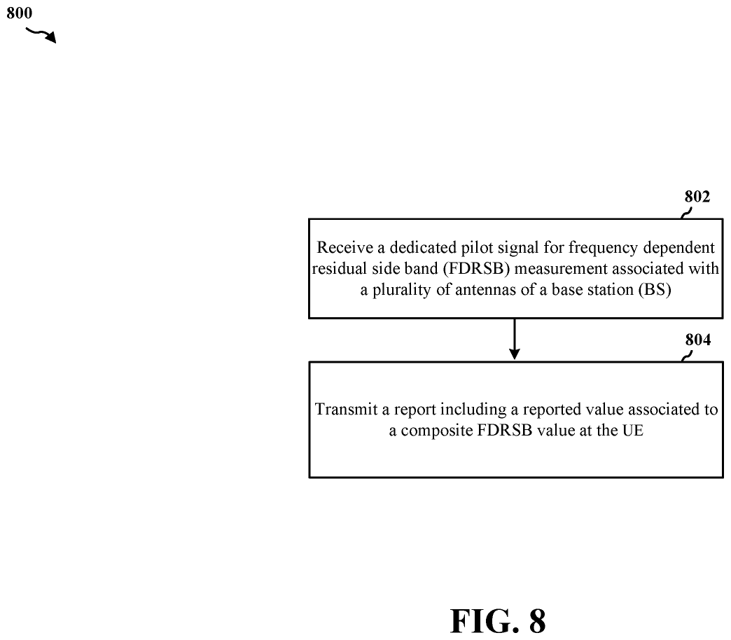

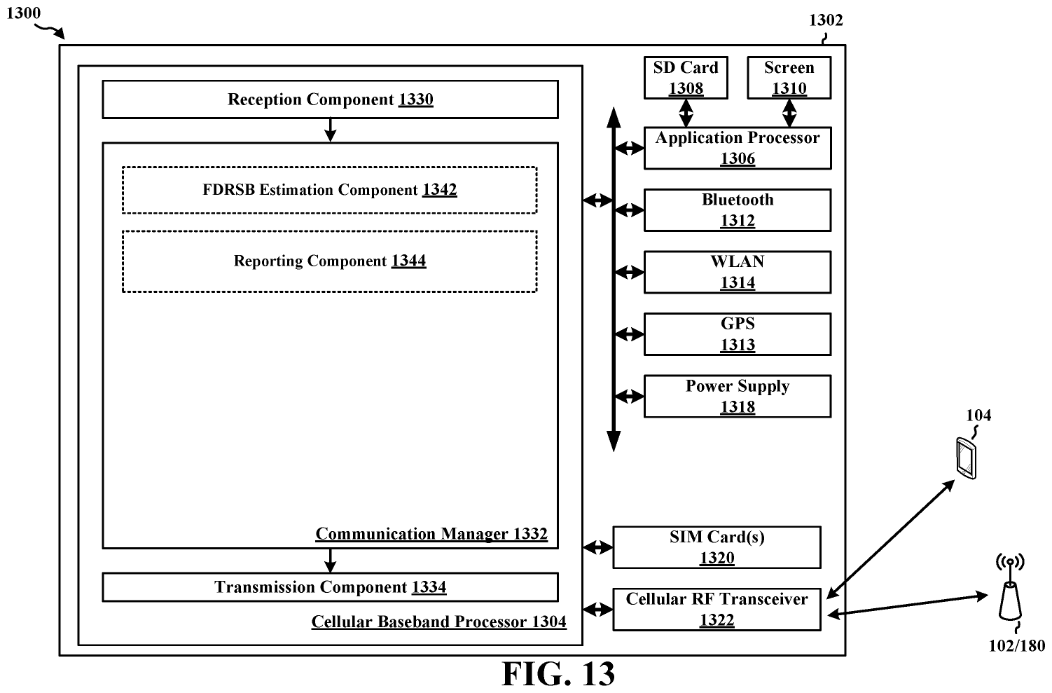

FIG. 8 is a flow chart of a method 800 of estimating FDRSB by a UE. The method may be performed by or at a UE (e.g., the UE 104, 450, 115a, 115b, 704), another wireless communications apparatus (e.g., the apparatus 1302 shown in FIG. 13), or one or more components thereof. According to various different aspects, one or more of the illustrated blocks of method 800 may be omitted, transposed, and/or contemporaneously performed. The method allows a UE to estimate a single composite response.

The method 800 may be performed by an apparatus, such as a FDRSB estimation component 199, as described above. In some implementations, the method 800 is performed by processing logic, including hardware, firmware, software, or a combination thereof. In some implementations, the method 800 is performed by a processor executing code stored in a non-transitory computer-readable medium (e.g., a memory).

At block 802, the UE may receive a dedicated pilot signal for frequency dependent residual side band (FDRSB) measurement associated with a plurality of antennas of a base station (BS). In an aspect, the apparatus may be a UE.

At block 804, the UE may transmit a report including a reported value associated to a composite FDRSB value at the UE. In an aspect, the report may be transmitted on dedicated resource allocated by the BS for uplink communication. In some aspects, the report may be transmitted via an analog signal on a resource allocated by the BS for uplink communication.

In an aspect, the composite FDRSB may be a weighted sum of individual FDRSB measurements corresponding to different IQ modulators of the BS. In an aspect, the composite FDRSB may be beam dependent.

In an aspect, estimation of the FDRSB measurement is based on performing channel estimation, performing a minimum mean-squared error (MMSE) equalization based on the channel estimation and performing a correlation with a conjugate of the dedicated pilot signal. For example, referring back to FIG. 7, at 718, the UE 704 may estimate FDRSB measurement associated with each antenna of the BS.

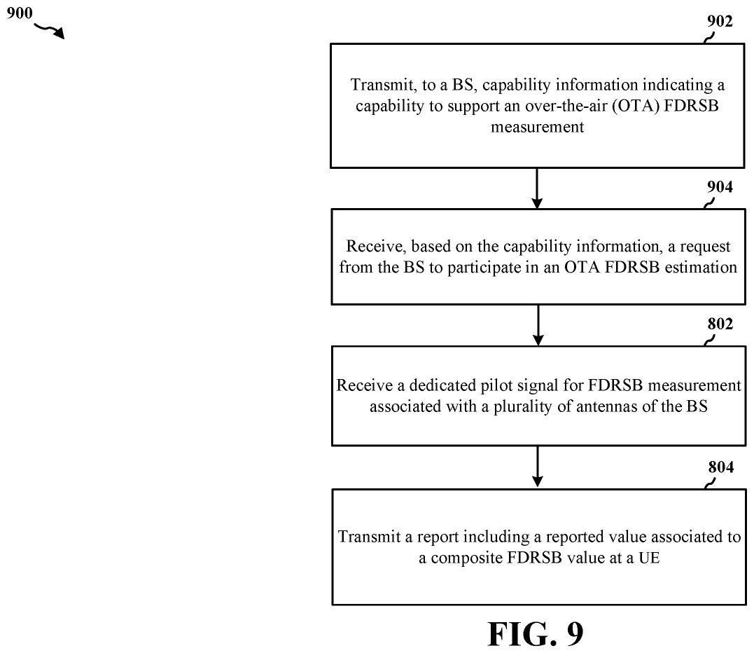

FIG. 9 is a flow chart of a method 900 of OTA FDRSB estimation. The method may be performed by or at a UE (e.g., the UE 104, 450, 115a, 115b, 704), another wireless communications apparatus (e.g., the apparatus 1302 shown in FIG. 13), or one or more components thereof. According to various different aspects, one or more of the illustrated blocks of method 900 may be omitted, transposed, and/or contemporaneously performed. The method allows a UE to estimate a single composite response.

The method 900 may be performed by an apparatus, such as a FDRSB estimation component 199, as described above. In some implementations, the method 900 is performed by processing logic, including hardware, firmware, software, or a combination thereof. In some implementations, the method 900 is performed by a processor executing code stored in a non-transitory computer-readable medium (e.g., a memory). In such methods 900, blocks 802 and 804, are performed as described above in connection to FIG. 8.

At block 902, the UE may transmit, to a BS, capability information indicating a capability to support an over-the-air (OTA) FDRSB measurement. For example, referring to FIG. 6A, the UEs 115a and 115b may publish capabilities to support OTA FDRSB measurement. As another example, referring to FIG. 7, at 712, the UE 704 may transmit capability information indicating a capability to support an OTA FDRSB.

At block 904, the UE may receive, based on the capability information, a request from the BS to participate in an OTA FDRSB estimation. For example, referring to FIG. 6B, the BS 105a transmit a request to participate in OTA FDRSB estimation to the UEs 115a and 115b. As another example, referring to FIG. 7, at 714, the UE 704 receives a request from a BS to participate in an OTA FDRSB estimation.

In an aspect, the method 900 may include precoding a transmission by dividing the transmission by a mathematical representation of a channel between the apparatus and the bs before transmitting the report via the analog signal.

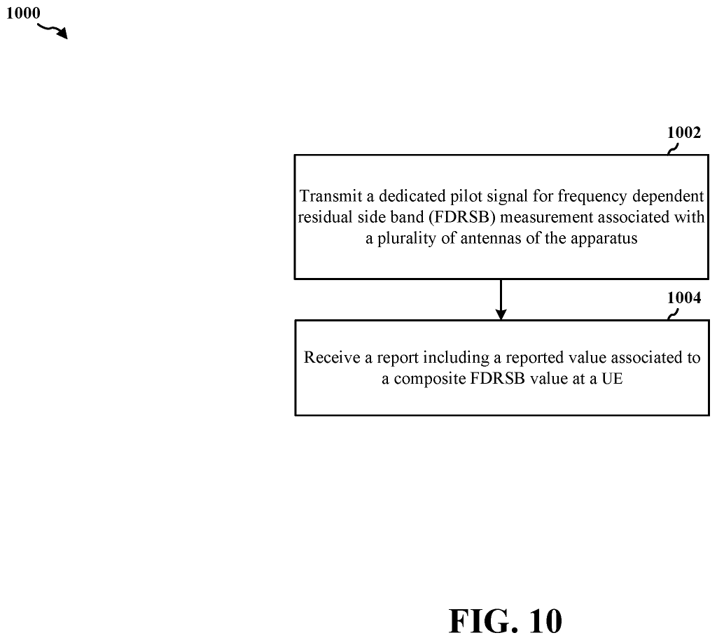

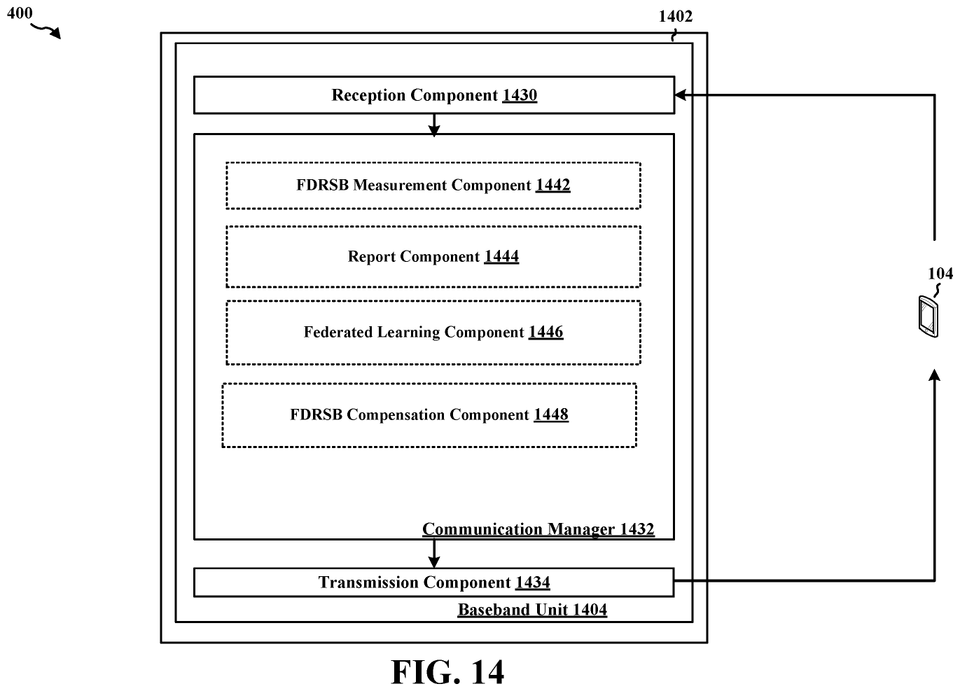

FIG. 10 is a flow chart of a method 1000 of OTA FDRSB estimation. The method may be performed by or at a BS (e.g., the BS 102/180, 410, 105a), another wireless communications apparatus (e.g., the apparatus 1402 shown in FIG. 14), or one or more components thereof. According to various different aspects, one or more of the illustrated blocks of method 1000 may be omitted, transposed, and/or contemporaneously performed. The method allows a BS to receive an estimated composite FDRSB for the transmitter to use to compensate the FDRSB of its IQ modulators.

The method 1000 may be performed by an apparatus, such as FDRSB compensation component 198, as described above. In some implementations, the method 1000 is performed by processing logic, including hardware, firmware, software, or a combination thereof. In some implementations, the method 1000 is performed by a processor executing code stored in a non-transitory computer-readable medium (e.g., a memory).

At 1002, the apparatus may transmit a dedicated pilot signal for frequency dependent residual side band (FDRSB) measurement associated with a plurality of antennas of the apparatus. For example, referring back to FIG. 6C, the BS 105a transmit a dedicated pilot to use for FDRSB measurement. As another example, referring back to FIG. 7, the UE 704 receives a dedicated pilot signal for FDRSB measurement associated with a plurality of antennas of the BS 716.

At 1004, the apparatus may receive a report including a reported value associated to a composite FDRSB value at the apparatus. For example referring back to FIG. 6D, the UEs 115a and 115b respond with a report. As another example, referring back to FIG. 7, the UE 704 transmits a report including a reported value associated to a composite FDRSB value at the UE 720.

In an aspect, the apparatus may be a BS.

In an aspect, the composite FDRSB may be a weighted sum of individual FDRSB measurements corresponding to different IQ modulators of the apparatus. In an aspect, the composite FDRSB may be beam dependent.

In an aspect, estimation of the FDRSB measurement is based on performing channel estimation, performing a minimum mean-squared error (MMSE) equalization based on the channel estimation, and performing a correlation with a conjugate of the dedicated pilot signal.

In some aspects, the report may be received on dedicated resource allocated by the apparatus for uplink communication. In some aspects, the report may be received via an analog signal on a resource allocated by the apparatus for uplink communication.

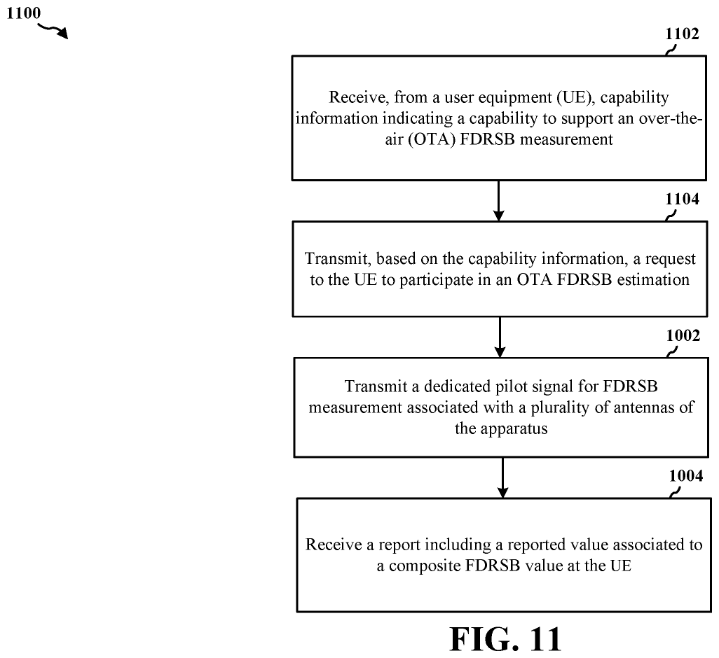

FIG. 11 is a flow chart method 1100 of OTA FDRSB estimation. The method may be performed by or at a BS (e.g., the BS 102/180, 410, 105a), another wireless communications apparatus (e.g., the apparatus 1402 shown in FIG. 14), or one or more components thereof. According to various different aspects, one or more of the illustrated blocks of method 1100 may be omitted, transposed, and/or contemporaneously performed. The method allows a BS to receive an estimated composite FDRSB for the transmitter to use to compensate the FDRSB of its IQ modulators.

The method 1100 may be performed by an apparatus, such as the FDRSB compensation component 198, as described above. In some implementations, the method 1000 is performed by processing logic, including hardware, firmware, software, or a combination thereof. In some implementations, the method 1100 is performed by a processor executing code stored in a non-transitory computer-readable medium (e.g., a memory). In such methods 1100, blocks 1002 and 1004 are performed as described above in connection to FIG. 10.

At 1102, the apparatus may receive, from a user equipment (UE), capability information indicating a capability to support an over-the-air (OTA) FDRSB measurement.

At 1104, the apparatus may transmit, based on the capability information, a request to the UE to participate in an OTA FDRSB estimation.

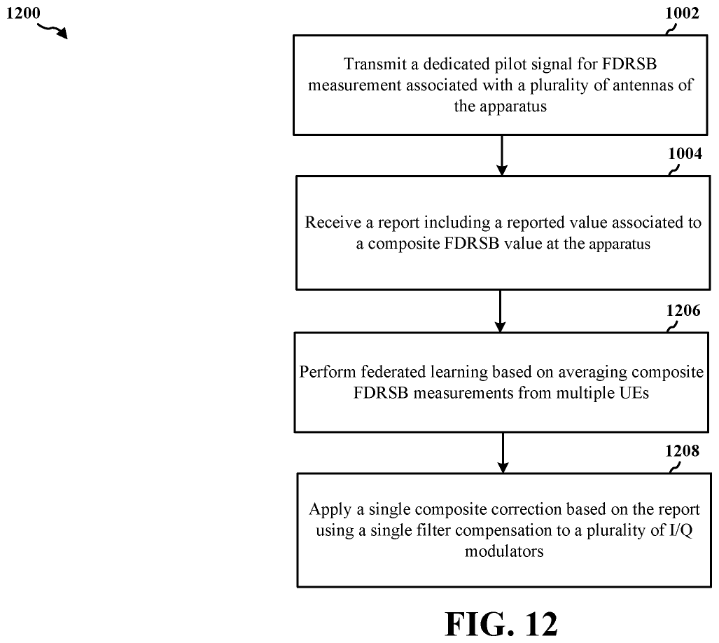

FIG. 12 is a flow chart method 1200 of OTA FDRSB estimation. The method may be performed by or at a BS (e.g., the BS 102/180, 410, 105a), another wireless communications apparatus (e.g., the apparatus 1402 shown in FIG. 14), or one or more components thereof. According to various different aspects, one or more of the illustrated blocks of method 1200 may be omitted, transposed, and/or contemporaneously performed. The method allows a BS to receive an estimated composite FDRSB for the transmitter to use to compensate the FDRSB of its IQ modulators.

The method 1200 may be performed by an apparatus, such as FDRSB compensation component 198, as described above. In some implementations, the method 1200 is performed by processing logic, including hardware, firmware, software, or a combination thereof. In some implementations, the method 1200 is performed by a processor executing code stored in a non-transitory computer-readable medium (e.g., a memory). In such methods 1200, blocks 1002 and 1004 are performed as described above in connection to FIG. 10.

At block 1206, the apparatus may perform federated learning based on averaging composite FDRSB measurements from multiple UEs.

At block 1208, the apparatus may apply a single composite correction based on the report using a single filter compensation to a plurality of I/Q modulators.

FIG. 13 is a diagram 1300 illustrating an example of a hardware implementation for an apparatus 1302. The apparatus 1302 may be a UE or similar device, or the apparatus 1302 may be a component of a UE or similar device. The apparatus 1302 may include a cellular baseband processor 1304 (also referred to as a modem) and/or a cellular RF transceiver 1322, which may be coupled together and/or integrated into the same package, component, circuit, chip, and/or other circuitry.

In some aspects, the apparatus 1302 may accept or may include one or more subscriber identity modules (SIM) cards 1320, which may include one or more integrated circuits, chips, or similar circuitry, and which may be removable or embedded. The one or more SIM cards 1320 may carry identification and/or authentication information, such as an international mobile subscriber identity (IMSI) and/or IMSI-related key(s). Further, the apparatus 1302 may include one or more of an application processor 1306 coupled to a secure digital (SD) card 1308 and a screen 1310, a Bluetooth module 1312, a wireless local area network (WLAN) module 1314, a Global Positioning System (GPS) module 1313, and/or a power supply 1318.

The cellular baseband processor 1304 communicates through the cellular RF transceiver 1322 with the UE 104 and/or base station 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304.

In the context of FIG. 4, the cellular baseband processor 1304 may be a component of the UE 450 and may include the memory 460 and/or at least one of the TX processor 468, the RX processor 456, and/or the controller/processor 459. In one configuration, the apparatus 1302 may be a modem chip and/or may be implemented as the baseband processor 1304, while in another configuration, the apparatus 1302 may be the entire UE (e.g., the UE 450 of FIG. 4) and may include some or all of the abovementioned components, circuits, chips, and/or other circuitry illustrated in the context of the apparatus 1302. In one configuration, the cellular RF transceiver 1322 may be implemented as at least one of the transmitter 454TX and/or the receiver 454RX.

The reception component 1330 may be configured to receive signaling on a wireless channel, such as signaling from a base station 102/180 or UE 104. The transmission component 1334 may be configured to transmit signaling on a wireless channel, such as signaling to a base station 102/180 or UE 104. The communication manager 1332 may coordinate or manage some or all wireless communications by the apparatus 1302, including across the reception component 1330 and the transmission component 1334.

The reception component 1330 may provide some or all data and/or control information included in received signaling to the communication manager 1332, and the communication manager 1332 may generate and provide some or all of the data and/or control information to be included in transmitted signaling to the transmission component 1334. The communication manager 1332 may include the various illustrated components, including one or more components configured to process received data and/or control information, and/or one or more components configured to generate data and/or control information for transmission.

The communication manager 1332 includes a FDRSB Estimation Component 1342 and is configured to receive a dedicated pilot signal for frequency dependent residual side band (FDRSB) measurement associated with a plurality of antennas of a base station, e.g., as described in connection with block 802 from FIG. 8. The communication manager 1332 further includes a Reporting Component 1344 and is configured to transmit a including a reported value associated to a composite FDRSB value at the UE, e.g., as described in connection with block 804 from FIG. 8.

The apparatus 1302 may include additional components that perform some or all of the blocks, operations, signaling, etc. of the algorithm(s) in the aforementioned call flow diagram(s) and/or flowchart(s) of FIGS. 6A-9. As such, some or all of the blocks, operations, signaling, etc. in the aforementioned call flow diagram(s) and/or flowchart(s) of FIGS. 6A-9 may be performed by one or more components and the apparatus 1302 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband processor 1704, may include means for: receiving a dedicated pilot signal for frequency dependent residual side band (FDRSB) measurement associated with a plurality of antennas of a base station (BS); and means for transmitting a report including a composite FDRSB based on an estimation of the FDRSB measurement associated with each antenna among the plurality of antennas of the BS.

In one configuration, the apparatus 1302, and in particular the baseband processor 1704, may include means for: transmit, to the BS, capability information indicating a capability to support an over-the-air (OTA) FDRSB measurement; and receive, based on the capability information, a request from the BS to participate in an OTA FDRSB estimation.

In one configuration, the apparatus 1302, and in particular the baseband processor 1704, may include means for: precoding a transmission by dividing the transmission by a mathematical representation of a channel between the apparatus and the bs before transmitting the report via the analog signal.

The aforementioned means may be one or more of the aforementioned components of the apparatus 1302 configured to perform the functions recited by the aforementioned means. As described supra, the apparatus 1302 may include the TX Processor 468, the RX Processor 456, and the controller/processor 459. As such, in one configuration, the aforementioned means may be the TX Processor 468, the RX Processor 456, and the controller/processor 459 configured to perform the functions recited by the aforementioned means.

FIG. 14 is a diagram 1400 illustrating an example of a hardware implementation for an apparatus 1402. The apparatus 1402 may be a base station or similar device or system, or the apparatus 1402 may be a component of a base station or similar device or system. The apparatus 1402 may include a baseband unit 1404. The baseband unit 1404 may communicate through a cellular RF transceiver. For example, the baseband unit 1404 may communicate through a cellular RF transceiver with a UE 104, such as for downlink and/or uplink communication, and/or with a base station 102/180, such as for IAB.

The baseband unit 1404 may include a computer-readable medium/memory, which may be non-transitory. The baseband unit 1404 is responsible for general processing, including the execution of software stored on the computer-readable medium/memory. The software, when executed by the baseband unit 1404, causes the baseband unit 1404 to perform the various functions described supra. The computer-readable medium/memory may also be used for storing data that is manipulated by the baseband unit 1404 when executing software. The baseband unit 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the baseband unit 1404. The baseband unit 1404 may be a component of the base station 410 and may include the memory 476 and/or at least one of the TX processor 416, the RX processor 470, and the controller/processor 475.

The reception component 1430 may be configured to receive signaling on a wireless channel, such as signaling from a UE 104 or base station 102/180. The transmission component 1434 may be configured to transmit signaling on a wireless channel, such as signaling to a UE 104 or base station 102/180. The communication manager 1432 may coordinate or manage some or all wireless communications by the apparatus 1402, including across the reception component 1430 and the transmission component 1434.

The reception component 1430 may provide some or all data and/or control information included in received signaling to the communication manager 1432, and the communication manager 1432 may generate and provide some or all of the data and/or control information to be included in transmitted signaling to the transmission component 1434. The communication manager 1432 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 1432 includes a FDRSB measurement component 1442 and is configured to transmit a dedicated pilot signal for frequency dependent residual side band (FDRSB) measurement associated with a plurality of antennas of the apparatus, e.g., as described in connection with block 1002 from FIG. 10. The communication manager 1432 further includes a Report Component 1444 and is configured to receive a report including a reported value associated to a composite FDRSB value at the UE, e.g., as described in connection with block 1004 from FIG. 10.

In some aspects, the communication manager 1432 further includes a Federated Learning Component 1446 and is configured to perform federated learning based on averaging composite FDRSB measurements from multiple UEs, e.g., as described in connection with block 1206 from FIG. 12. In some aspects, the communication manager 1432 further includes a FDRSB compensation component 1448 and is configured to apply a single composite correction based on the report using a single filter compensation to a plurality of I/Q modulators, e.g., as described in connection with block 1208 from FIG. 12.

The apparatus 1402 may include additional components that perform some or all of the blocks, operations, signaling, etc. of the algorithm(s) in the aforementioned call flow diagram(s) and/or flowchart(s) of FIGS. 6-7 and 10-12. As such, some or all of the blocks, operations, signaling, etc. in the aforementioned call flow diagram(s) and/or flowchart(s) of FIGS. 6-7 and 10-12 may be performed by a component and the apparatus 1402 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the baseband unit 1404, may include means for: transmitting a dedicated pilot signal for frequency dependent residual side band (FDRSB) measurement associated with a plurality of antennas of the apparatus; and receiving a report including a reported value associated to a composite FDRSB value at the UE.

In one configuration, the apparatus 1402, and in particular the baseband unit 1404, may include means for: receiving, from a user equipment (UE), capability information indicating a capability to support an over-the-air (OTA) FDRSB measurement; and transmitting, based on the capability information, a request to the UE to participate in an OTA FDRSB estimation.

In one configuration, the apparatus 1402, and in particular the baseband unit 1404, may include means for: perform federated learning based on averaging composite FDRSB measurements from multiple UEs.

In one configuration, the apparatus 1402, and in particular the baseband unit 1404, may include means for: applying a single composite correction based on the report using a single filter compensation to a plurality of I/Q modulators.

The aforementioned means may be one or more of the aforementioned components of the apparatus 1402 configured to perform the functions recited by the aforementioned means. As described supra, the apparatus 1402 may include the TX Processor 416, the RX Processor 470, and the controller/processor 475. As such, in one configuration, the aforementioned means may be the TX Processor 416, the RX Processor 470, and the controller/processor 475 configured to perform the functions recited by the aforementioned means.

Aspects of the present disclosure allow for a more efficient way to correct or compensate for IQ mismatch in an environment with multiple TX antennas and multiple IQ modulators. Specifically, aspects of the present disclosure estimate the FDRSB composite on-line by over-the-air (OTA) computation and having the UEs assist a base station in estimating the composite FDRSB. This allows multiple FDRSB measurements to be represented and estimated by a single FDRSB which saves resources for estimation and signaling when the estimation is performed on the RX side. For instance, the RX side may estimate the composite FDRSB for the TXs and signal back a composite FDRSB to allow the TX to use a single filter to compensate for the composite FDRSB. The composite FDRSB may correspond to the equivalent FDRSB received as a sum of the individual FDRSBS of each of the IQ modulators and IQ antennas at a base station.

As demand for wireless communication efficiency increases, various aspects of the present disclosure may provide improvements to IQ mismatch estimation to support higher reliability and lower latency wireless communication. The techniques described below allow a shorter training because there is no need to send a training signal to every IQ modulator separately and instead training is performed on the composite signal. In addition, there is a lower cost of hardware because there is no longer a need to have a feedback pass per each IQ modulator. Furthermore, better estimation and cancellation accuracy is possible because the base station may utilize multiple UEs for estimating the composite FDRSB via federated learning. The base station may request many way to estimate the composite FDRSB and average the feedback. Thus, the quality and accuracy of the estimation is improved.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

### SOME ADDITIONAL EXAMPLES

The following examples are illustrative only and may be combined with aspects of other embodiments or teachings described herein, without limitation.

Aspect 1. An apparatus for wireless communication at a user equipment (UE), comprising:
a memory; and
at least one processor coupled to the memory and configured to:
receive a dedicated pilot signal for frequency dependent residual side band (FDRSB) measurement associated with a plurality of antennas of a base station (BS); and
transmit a report including a reported value associated to a composite FDRSB value at the apparatus.

Aspect 2. The apparatus of aspect 1, wherein the at least one processor is further configured to:
transmit, to the BS, capability information indicating a capability to support an over-the-air (OTA) FDRSB measurement; and
receive, based on the capability information, a request from the BS to participate in an OTA FDRSB estimation.

Aspect 3. The apparatus of aspects 1 or 2, wherein the apparatus is a user equipment (UE).

Aspect 4. The apparatus of any of the aspects 1 to 3, wherein the composite FDRSB is a weighted sum of individual FDRSB measurements corresponding to different IQ modulators of the BS.

Aspect 5. The apparatus of any of the aspects 1 to 4, wherein the composite FDRSB is beam dependent.

Aspect 6. The apparatus of any of the aspects 1 to 5, wherein estimation of the FDRSB measurement is based on:
performing channel estimation;
performing a minimum mean-squared error (MMSE) equalization based on the channel estimation; and
   performing a correlation with a conjugate of the dedicated pilot signal.

Aspect 7. The apparatus of any of the aspects 1 to 6, wherein the report is transmitted on dedicated resource allocated by the BS for uplink communication.

Aspect 8. The apparatus of any of the aspects 1 to 7, wherein the report is transmitted via an analog signal on a resource allocated by the BS for uplink communication.

Aspect 9. The apparatus of any of the aspects 1 to 8, wherein the at least one processor is further configured to:

precode a transmission by dividing the transmission by a mathematical representation of a channel between the apparatus and the BS before transmitting the report via the analog signal.

Aspect 10. An apparatus for wireless communication, comprising:
a memory;
a plurality of antennas for transmitting a wireless signal; and
at least one processor coupled to the memory and configured to:
transmit a dedicated pilot signal for frequency dependent residual side band (FDRSB) measurement associated with a plurality of antennas of the apparatus; and
receive a report including a reported value associated to a composite FDRSB value at the apparatus

Aspect 11. The apparatus of any of the aspects 1 to 10, wherein the at least one processor is further configured to:
receive, from a user equipment (UE), capability information indicating a capability to support an over-the-air (OTA) FDRSB measurement; and
transmit, based on the capability information, a request to the UE to participate in an OTA FDRSB estimation.

Aspect 12. The apparatus of any of the aspects 1 to 11, wherein the apparatus is a base station (BS).

Aspect 13. The apparatus of any of the aspects 1 to 12, wherein the composite FDRSB is a weighted sum of individual FDRSB measurements corresponding to different IQ modulators of the apparatus.

Aspect 14. The apparatus of any of the aspects 1 to 13, wherein the composite FDRSB is beam dependent

Aspect 15. The apparatus of any of the aspects 1 to 14, wherein estimation of the FDRSB measurement is based on:
performing channel estimation;
performing a minimum mean-squared error (MMSE) equalization based on the channel estimation; and
   performing a correlation with a conjugate of the dedicated pilot signal.

Aspect 16. The apparatus of any of the aspects 1 to 15, wherein the report is received on dedicated resource allocated by the apparatus for uplink communication.

Aspect 17. The apparatus of any of the aspects 1 to 16, wherein the report is received via an analog signal on a resource allocated by the apparatus for uplink communication.

Aspect 18. The apparatus of any of the aspects 1 to 17, wherein the at least one processor is further configured to:
perform federated learning based on averaging composite FDRSB measurements from multiple UEs.

Aspect 19. The apparatus of any of the aspects 1 to 18, wherein the at least one processor is further configured to:
apply a single composite correction based on the report using a single filter compensation to a plurality of I/Q modulators.

Aspect 20. A method of wireless communication at a user equipment (UE), comprising:
receiving a dedicated pilot signal for frequency dependent residual side band (FDRSB) measurement associated with a plurality of antennas of a base station (BS); and
transmitting a report including a reported value associated to a composite FDRSB value at the UE.

Aspect 21. The apparatus of the aspect 20, further comprising:
transmitting, to the BS, capability information indicating a capability to support an over-the-air (OTA) FDRSB measurement; and
receiving, based on the capability information, a request from the BS to participate in an OTA FDRSB estimation.

Aspect 22. The apparatus of any of the aspects 20 or 21, wherein the composite FDRSB is a weighted sum of individual FDRSB measurements corresponding to different IQ modulators of the BS.

Aspect 23. The apparatus of any of the aspects 20 to 22, wherein the composite FDRSB is beam dependent.

Aspect 24. The apparatus of any of the aspects 20 to 23, wherein estimation of the FDRSB measurement is based on:
performing channel estimation;
performing a minimum mean-squared error (MMSE) equalization based on the channel estimation; and
performing a correlation with a conjugate of the dedicated pilot signal.

Aspect 25. The apparatus of any of the aspects 20 to 24, wherein the report is transmitted on dedicated resource allocated by the BS for uplink communication.

Aspect 26. A method of wireless communication at a base station (BS), comprising:
transmitting a dedicated pilot signal for frequency dependent residual side band (FDRSB) measurement associated with a plurality of antennas of the BS; and
receiving a report including a reported value associated to a composite FDRSB value at a UE.

Aspect 27. The method of the aspect 26, further comprising:
receiving, from a user equipment (UE), capability information indicating a capability to support an over-the-air (OTA) FDRSB measurement; and
transmitting, based on the capability information, a request to the UE to participate in an OTA FDRSB estimation.

Aspect 28. The method of the aspects 26 or 27, wherein the composite FDRSB is a weighted sum of individual FDRSB measurements corresponding to different IQ modulators of the BS.

Aspect 29. The method of any of the aspects 26 to 28, wherein the composite FDRSB is beam dependent.

Aspect 30. The method of any of the aspects 26 to 29, wherein estimation of the FDRSB measurement is based on:
performing channel estimation;
performing a minimum mean-squared error (MMSE) equalization based on the channel estimation; and
performing a correlation with a conjugate of the dedicated pilot signal.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication, comprising:
a memory; and
at least one processor coupled to the memory and configured to:
receive a dedicated pilot signal for frequency dependent residual side band (FDRSB) measurement associated with a plurality of antennas of a base station (BS); and
transmit a report including a reported value associated to a composite FDRSB value at the apparatus.

2. The apparatus of claim 1, wherein the at least one processor is further configured to:
transmit, to the BS, capability information indicating a capability to support an over-the-air (OTA) FDRSB measurement; and
receive, based on the capability information, a request from the BS to participate in an OTA FDRSB estimation.

3. The apparatus of claim 1, wherein the apparatus is a user equipment (UE).

4. The apparatus of claim 1, wherein the composite FDRSB is a weighted sum of individual FDRSB corresponding to different IQ modulators of the BS.

5. The apparatus of claim 1, wherein the composite FDRSB is beam dependent.

6. The apparatus of claim 1, wherein estimation of the FDRSB measurement is based on:
performing channel estimation;
performing a minimum mean-squared error (MMSE) equalization based on the channel estimation; and
performing a correlation with a conjugate of the dedicated pilot signal.

7. The apparatus of claim 1, wherein the report is transmitted on dedicated resource allocated by the BS for uplink communication.

8. The apparatus of claim 1, wherein the report is transmitted via an analog signal on a resource allocated by the BS for uplink communication.

9. The apparatus of claim 8, wherein the at least one processor is further configured to:
precode a transmission by dividing the transmission by a mathematical representation of a channel between the apparatus and the BS before transmitting the report via the analog signal.

10. An apparatus for wireless communication, comprising:
a memory;
a plurality of antennas for transmitting a wireless signal; and
at least one processor coupled to the memory and configured to:
transmit a dedicated pilot signal for frequency dependent residual side band (FDRSB) measurement associated with a plurality of antennas of the apparatus; and
receive report including a reported value associated to a composite FDRSB value at a user equipment (UE).

11. The apparatus of claim 10, wherein the at least one processor is further configured to:
receive, from the UE, capability information indicating a capability to support an over-the-air (OTA) FDRSB measurement; and
transmit, based on the capability information, a request to the UE to participate in an OTA FDRSB estimation.

12. The apparatus of claim 10, wherein the apparatus is a base station (BS).

13. The apparatus of claim 10, wherein the composite FDRSB is a weighted sum of individual FDRSB corresponding to different IQ modulators of the apparatus.

14. The apparatus of claim 10, wherein the composite FDRSB is beam dependent.

15. The apparatus of claim 10, wherein estimation of the FDRSB measurement is based on:
performing channel estimation;
performing a minimum mean-squared error (MMSE) equalization based on the channel estimation; and
performing a correlation with a conjugate of the dedicated pilot signal.

16. The apparatus of claim 10, wherein the report is received on dedicated resource allocated by the apparatus for uplink communication.

17. The apparatus of claim 10, wherein the report is received via an analog signal on a resource allocated by the apparatus for uplink communication.

18. The apparatus of claim 10, wherein the at least one processor is further configured to:
perform federated learning based on averaging composite FDRSB measurements from multiple UEs.

19. The apparatus of claim 10, wherein the at least one processor is further configured to:
apply a single composite correction based on the report using a single filter compensation to a plurality of I/Q modulators.

20. A method of wireless communication at a user equipment (UE), comprising:
receiving a dedicated pilot signal for frequency dependent residual side band (FDRSB) measurement associated with a plurality of antennas of a base station (BS); and
transmitting report including a reported value associated to a composite FDRSB value at the UE.

21. The method of claim 20, further comprising:
transmitting, to the BS, capability information indicating a capability to support an over-the-air (OTA) FDRSB measurement; and
receiving, based on the capability information, a request from the BS to participate in an OTA FDRSB estimation.

22. The method of claim 20, wherein the composite FDRSB is a weighted sum of individual FDRSB corresponding to different IQ modulators of the BS.

23. The method of claim 20, wherein the composite FDRSB is beam dependent.

24. The method of claim 20, wherein estimation of the FDRSB measurement is based on:
performing channel estimation;
performing a minimum mean-squared error (MMSE) equalization based on the channel estimation; and
performing a correlation with a conjugate of the dedicated pilot signal.

25. The method of claim 20, wherein the report is transmitted on dedicated resource allocated by the BS for uplink communication.

26. A method of wireless communication at a base station (BS), comprising:
transmitting a dedicated pilot signal for frequency dependent residual side band (FDRSB) measurement associated with a plurality of antennas of the BS; and
receiving report including a reported value associated to a composite FDRSB value at a user equipment (UE).

27. The method of claim 26, further comprising:
receiving, from a user equipment (UE), capability information indicating a capability to support an over-the-air (OTA) FDRSB measurement; and
transmitting, based on the capability information, a request to the UE to participate in an OTA FDRSB estimation.

28. The method of claim 26, wherein the composite FDRSB is a weighted sum of individual FDRSB corresponding to different IQ modulators of the BS.

29. The method of claim 26, wherein the composite FDRSB is beam dependent.

30. The method of claim 26, wherein estimation of the FDRSB measurement is based on:
performing channel estimation;
performing a minimum mean-squared error (MMSE) equalization based on the channel estimation; and
performing a correlation with a conjugate of the dedicated pilot signal.
